(19) United States
(12) Patent Application Publication
(10) Pub. No.: US 2024/0232860 A9
(43) Pub. Date: Jul. 11, 2024

(54) Method and System for Transferring a Digital Asset and for Managing a Digital Wallet Application

(71) Applicant: IMAGENPAY UK LIMITED, Cheshire (GB)

(72) Inventors: Michael Donald, Cheshire (GB); Alexander Donald, Cheshire (GB)

(21) Appl. No.: 18/364,165

(22) Filed: Aug. 2, 2023

Related U.S. Application Data
(63) Continuation of application No. 17/056,365, filed on Nov. 17, 2020, now abandoned.

(30) Foreign Application Priority Data
May 18, 2018 (GB) 1808110.9
Oct. 15, 2018 (GB) 1816749.4
Oct. 15, 2018 (GB) 1816750.2

(51) Int. Cl. G06Q 20/36; G06Q 20/06; G06Q 20/34; G06Q 30/0226

(52) U.S. Cl. CPC G06Q 20/3674; G06Q 20/0658; G06Q 20/351; G06Q 20/3678; G06Q 30/0232

(57) ABSTRACT

The method comprises transferring a digital asset from a first user to a second user. The method comprises authenticating the first user as the owner of the digital asset by inspecting a transaction database. The method comprises transferring the digital asset from the first user to the second user by updating the transaction database so as to identify the second user as the owner of the digital asset; and by providing a graphic asset associated with the digital asset to a user electronic device of the second user. The transfer of the digital asset may be validated using a distributed ledger such as a blockchain. The method may be performed by a system 800 comprising user electronic devices 200A, 200B, 200C, and a transaction database 801. The system comprises a user electronic device 200 comprising a communicator 201, and a processor 207 communicatively coupled to the communicator 201.

This is a Continuation application of U.S. application Ser. No. 17/056,365 filed on Nov. 17, 2020, which is a U.S. National Stage of International Application No. PCT/EP2019/063009 filed May 20, 2019, which claims the benefit of and priority to Great Britain Application No. 1808110.9 filed May 18, 2018, Great Britain Application No. 1816750.2 filed Oct. 15, 2018, and Great Britain Application No. 1816749.4 filed Oct. 15, 2018, the disclosures of which are hereby incorporated by reference in their entireties.

The present invention is directed towards a method and system for transferring a digital asset. The present invention also relates to a system, method, and device for managing a digital wallet application. In particular, the present invention relates generally to a system, method and device, for managing the graphic assets applied to digitised transaction cards within a digital wallet application. The present invention also relates to a system, method, and device for managing a digital wallet application.

It is common for consumers to utilise a digital wallet application running on a user electronic device to perform electronic transactions. For example, digital wallet applications may be used to transfer money for the payment of goods or services. The user electronic device is typically a mobile user device, in particular a mobile telecommunications device, such as a smartphone for example. The user electronic device will generally employ near-field communication (NFC) or a similar short-range communication protocol communication to enable a swift, contactless, transaction to be performed.

To be able to perform electronic transactions using a digital wallet application, a user, is typically required to upload information relating to their physical transaction cards (e.g. payment cards such as credit and debit cards, and loyalty cards) to a digital wallet payment system using the digital wallet application operating on the user electronic device. Known digital wallet payment applications and systems include Apple Pay®, Google Pay®, and Samsung Pay®. This information can be uploaded to the digital wallet application using a camera of the user electronic device, by manually entering the card details into the user electronic device or by importing the data from a separate application. A benefit of digitised wallet applications is that a user is not required to carry around a bulky physical wallet containing their physical transaction cards. Instead, the user may upload each of their cards to the digital wallet application so that only their user electronic device is required to perform transactions. This not only saves the user the hassle of carrying around many different cards for different purposes, but also removes the possibility of losing cards or having cards stolen.

It is known that physical transaction cards may be decorated with user specific images. Such physical transaction cards may have been created using a personalisation service provided by a transaction card provider. In other circumstances, some of the user's transaction cards may have been purchased through a specific promotion, such as a collaboration between a football club and card provider for example, and therefore may have specific artwork associated with it that is important to the user.

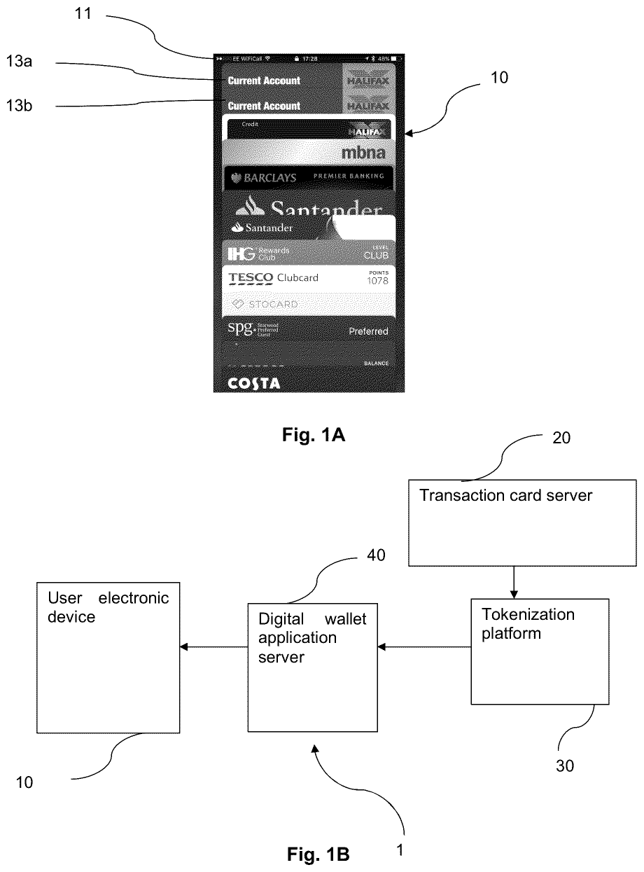

Digitised transaction cards stored in a digital wallet application are currently unable to be decorated with user specific images. This is because graphics used on transaction cards shown in the digital wallet are supplied from a graphic asset vault provided by a payment service provider (e.g. the provider of the transaction card, such as a bank), and are based on a generic identification number which identifies the payment service provider. This generic identification number is typically a BIN (Bank Identification Number). Because of this, the image on the physical transaction card may not correspond to the graphics shown on the representation of the transaction card in the digital wallet application. The BIN, which is an identifier that is unique to the transaction card provider is typically used as the mechanism by which specific graphics data is linked to a particular transaction card. Using this approach, it is not possible, therefore, to identify the year of issue of the physical card, the promotion by which the physical card was obtained, or any other image present on the physical card at the time of issue by using the BIN alone. This gives rise to the situation where the representations of transaction cards issued by one transaction card provider cannot be differentiated in the digitised payment wallet because each BIN is assigned generic graphics, and all digitised transaction cards having that BIN have a representation bearing those graphics in the digital payment wallet. An example of this problem is shown in FIG. 1A where a digital wallet application 11 is displayed running on a user electronic device 10. The digital wallet application 11 displays a number of digitised transaction cards. It can be seen that some of the digitised transaction cards 13a, 13b have the same graphical representation despite being associated with different current accounts. The reason for this is, as explained above, the graphic representations are linked only to the generic bank identification number.

FIG. 1B shows an example digital wallet application system architecture 1. The system 1 comprises a user electronic device 10, a transaction card server 20, a tokenization platform 30 and a digital wallet application server 40. The standard graphical representations linked to generic identification bank (or other entity) identification numbers are communicated to the user electronic device 10 from the transaction card server 20 via the tokenization platform 30 and digital wallet application server 40. The transaction card server 20 is operated by an entity that provides the digitised transaction card, e.g. a payment services provided or PSP. In some examples, this entity may be a bank that issues the digitised transaction card. The tokenization platform 30 may be part of the transaction card server 20 or may be provided by a separate entity. The digitised wallet application management server 20 may be operated by an entity that provides the digital wallet application on the user electronic device 10.

The existing digital wallet application system architecture 1 is not able to implement an update to each digitised transaction card or to individually personalise specific graphics within a digital wallet application. The system presently being used is a system that must interact with both physical payment schemes and digital wallets as well as other transaction card systems, and so is a legacy system. To alter the internal functions of the system to accommodate individual alteration of graphics in the graphic asset vault would require an overhaul of current operating practices and systems. This may cause problems with the speed of operation of the system and may cause problems for users.

Additionally, existing digital wallet applications allow for loyalty cards to be added to the digital wallet. A loyalty card refers to a card that may be used to collect and redeem points when a user makes a qualifying purchase for a particular loyalty scheme. An example of this could be airline schemes which could be attached to a credit card.

Merchants, and loyalty points providers want consumers to engage with their scheme, both to collect and redeem points, as this drives incremental sales and is a good reflection of their brand. Often, consumers are members of a number of loyalty scheme and will forget to collect points when they should, lose track of which scheme they are members of, lose engagement, or are simply unable to redeem points due to changes of circumstances. These loyalty points can have some significant value, and profitability of loyalty schemes are better served by encouraging members to be active, engaged, and get into the redemption cycle. This is due to the fact that happy and engaged customers tend to spend more with a brand. Loyalty schemes need to account for un-redeemed points as a liability, so while they are not having to spend money on points that have not been redeemed, it also means they cannot report that liability as profit. Most scheme providers prefer to have a high redemption rate, as this encourages those customers to purchase more from that brand or merchant.

It is an object of the present invention to improve on, or at least provide an alternative to, existing digital wallet application system architectures.

It is a further object of the present invention seeks to provide a retrofitting solution which is able to work with existing legacy systems.

It is further object of the present invention to provide greater flexibility in the handling of different types of transaction cards, such as loyalty cards or cards associated with a loyalty scheme, in a digital wallet application.

According to the present invention there is provided an system, method and device as set forth in the appended claims. Other features of the invention will be apparent from the dependent claims, and the description which follows.

According to an aspect of the present invention, there is provided a system. The system comprises a user electronic device. The user electronic device comprises a communicator, and a processor communicatively coupled to the communicator. The processor is operable to execute a digital wallet application. The digital wallet application, when executed, is arranged to display a graphic asset associated with a digitised transaction card. The processor of the user electronic device is further operable to obtain graphic asset preference information in relation to the digitised transaction card. The processor of the user electronic device is operable to control the communicator to communicate the graphic asset preference information to a management server. The processor of the user electronic device is operable to control the communicator to receive asset information for a replacement graphic asset. The replacement graphic asset is determined according to the graphic asset preference information. The processor of the user electronic device is operable to replace the graphic asset associated with the digitised transaction card with the replacement graphic asset according to the communicated asset information such that the digital wallet application, when executed, is arranged to display the replacement graphic asset associated with the digitised transaction card.

Significantly, the present invention enables the graphic asset associated with a digitised transaction card in a digital wallet application to be changed, by replacing the existing graphic asset with a replacement graphic asset. The replacement graphic asset is determined according to graphic asset preference information which is transmitted from the user electronic device to a management server. The management server in turn communicates asset information for the replacement graphic asset to the user electronic device. The management server effectively integrates into existing legacy system architectures managing digital wallet applications running on user electronic devices, without requiring a complete re-design of the existing system architectures such as existing transaction card servers and tokenization platforms, which may not be practical or plausible. The management server thus provides an efficient retro-fitting solution.

Moreover, the management server is able to control how the user electronic device updates graphic assets associated with digitised transaction cards. This may be beneficial in ensuring user compliance with the digital wallet system architecture, especially if certain graphic assets are associated with rewards or other forms of loyalty scheme. The management server is able to manage the transfer of asset information and control how/when the user electronic device updates the graphic asset associated with the digitised transaction card in the digital wallet application.

In view of the above, the present invention provides a way to integrate the functionality of updating graphic assets for digitised transaction cards into existing digital wallet application system architectures without requiring substantive re-design or modification of the existing system architectures. This means that the present invention is not directed towards just the concept of changing graphic assets for digitised transaction cards, but rather the technical means by which this is achieved. Generally, the advantage of having different graphic assets for each card is that each card becomes identifiable by the user quickly from the representations provided in the digital wallet application of the cards. Where the digital wallet application is provided on a smartphone for example, this is an important consideration as there is limited screen space to display all of the multitude of different cards which the user may have in the digital wallet and the ability to recognise the specific type of card from part of its image is very useful.

Here, ‘graphic asset’ refers generally to a graphic that may be used with a digitised transaction card and may visually represent the digitised transaction card. The graphic asset may be a static image, a movie, or a moving image such as a GIF. In the case of a series of moving images, the image on the digitised transaction card may move continually, or may move only when a payment is made, when the digital wallet application is first accessed or when the user interacts with the digital wallet application, amongst others. The graphic asset may refer to an icon with which the user can interact.

Here, ‘digitised transaction card’ may refer to a digitised representation of a physical transaction card. The transaction card may be a transaction card such as a debit or credit transaction card, a loyalty card, or a pre-paid transaction card.

The management server may be provided by a separate entity to the entity that provides the transaction card server.

The processor of the user electronic device may be operable to control the communicator to receive the asset information for the replacement graphic asset from the management server. This means that the asset information is received by the user electronic device from, e.g. directly, the management server rather than via the transaction card server. This means that multiple different entities (e.g. different transaction card servers and tokenization platforms) are not required to all hold copies of the replacement graphic assets, and instead a central copy may be maintained by the management server and access to the replacement graphic assets may be controlled through the communication of asset information by the management server. In this way, the synchronised update and storage of replacement graphic assets across multiple different entities is not required.

The processor of the user electronic device may be operable to control the communicator to receive the asset information for the replacement graphic asset from a transaction card server. The transaction card server is different to the management server/provided by a different entity. The asset information may be provided to the transaction card server from the management server. In this example, the established communication channel between the transaction card server and the user electronic device for communicating asset information is used to provide the asset information for the replacement graphic asset. This may be beneficial in allowing for easy integration into existing legacy systems.

In this example, the asset information may be provided to the transaction card server from the management server. In particular, the asset information may be provided to the management server via a content creator. This asset information may then be sent to the transaction card server. The transaction card server then may make the asset information available to a digital wallet application server. The asset information may be in the form of graphic assets data (e.g. images) or may be location information indicating a location where the graphics assets data may be obtained. Generally, the location information may be in the form of a uniform resource locator. The location may be a location in a data store of or associated with the management server. In response to receiving the asset information from the management server, the transaction card server may provide one or more identifiers (e.g. unique) for the asset information. Each identifier may correspond to a different graphic asset identified or included in the asset information. The identifiers enable the management server to subsequently identify a particular graphic asset to the transaction card server.

The graphic asset preference information may be determined according to a location of the user electronic device.

The graphic asset preference information may be determined according to a current time of the user electronic device in addition to or separately to the location of the user electronic device. Here, “time” may refer to the time of day or the current date and time. In this way, the graphic asset preference information may indicate the current date and time. In this way, the graphic asset for the digitised transaction card may be updated to relate to particular events such as a user's birthday, a weekly or daily change, public holidays, sports events or music events.

The graphic asset preference information may be determined according to a merchant setting in addition to or separately to the location of the user electronic device and/or the current time of the user electronic device. In this way, the graphic assets may be updated in a way specified by a merchant, e.g. to reflect a marketing promotion.

The graphic asset preference information may comprise a random element in addition to or separately to the location of the user electronic device and/or the current time of the user electronic device and/or merchant setting. This may mean that the graphic asset preference information may denote a preference from a random graphic asset that may be selected by the management server from a plurality of available replacement graphic assets. The graphic asset preference information may comprise a random number for use in the selection of the replacement graphic asset.

The graphic asset preference information may be determined according to a user input received via a user interface of the user electronic device. That is, the graphic asset preference information may denote a user preference. The user input may be a touch or voice input.

The processor of the user electronic device may be operable to control the user interface to display a representation of a replacement graphic asset for selection by the user. In response to receiving a selection of the replacement graphic asset from the user, the processor of the user electronic device may be operable to control the communicator to communicate the selection of the representation of the replacement graphic asset to the management server.

The processor of the user electronic device may be operable to control the user interface to display representations of a plurality of different replacement graphic assets for selection by the user. The representation of the replacement graphic asset may be received from the management server.

The processor of the user electronic device may be operable to execute a consumer application for allowing the user to select and change graphic assets associated with the digitised transaction cards. The consumer application may be separate to the digital wallet application.

The consumer application, when executed by the processor of the user electronic device, may be arranged to display on the user interface of the user electronic device at least one of: a registration interface for receiving registration information from a user; an interface of digitised transaction card entries; and a preferences interface for allowing a user to select replacement graphic assets. The consumer application may comprise digitised transaction card identification software for identifying the digitised transaction cards of the digital wallet application. The consumer application may comprise or be associated with a library of available graphic assets for use as replacement graphic assets for digitised transaction cards in the digital wallet application.

The consumer application may be downloaded. The application may be sourced from an application store and/or content provider. The content provider may comprise a cloud computing provider.

The consumer application, when executed by the processor of the user electronic device, may operate the digitised transaction card identification software to identify the digitised transaction cards of the digital wallet application. The consumer application may separately or additionally identify the graphic asset preference information (e.g. the user's graphic preferences received via the preferences interface). The consumer application may separately or additionally update the graphic asset for the digitised transaction card for the digital wallet application. The consumer application may apply multiple graphics preferences/graphic assets to a single digitised transaction card.

The asset information may comprise a storage location of the replacement graphic asset. The processor of the user electronic device may be operable to obtain the replacement graphic asset from the storage location. The storage location may be provided in the form of a uniform resource locator, URL. The storage location may be in a data store of the management server.

The asset information may comprise the selected graphic asset.

The replacement graphic asset may be associated with a loyalty point scheme such that subsequent transactions performed using the digitised transaction card when associated with the replacement graphic asset generates loyalty points. The graphic asset preference information may indicate if the user prefers the digitised transaction card to be associated with a loyalty point scheme, and the replacement graphic asset may be provided in response to this graphic asset preference information. For example, the user may have a plurality of digitised transaction cards in their digital wallet application. The user may specify which of the digitised transaction cards they would like to be associated with the loyalty point scheme, and this user preference may be effected through the transmission of appropriate preference information to the management server.

The processor of the user electronic device may be operable to control the communicator to communicate the graphic asset preference information and an identifier for the digitised transaction card to the management server. The identifier may be a Primary Account Number (PAN) ID.

The system may further comprise the management server. The management server may comprise a communicator in communication with the communicator of the user electronic device, and a processor communicatively coupled to the communicator. The processor of the management server may be operable to control the communicator to receive the graphic asset preference information from the user electronic device. The processor of the management server may be operable to determine a replacement graphic asset according to the received graphic asset preference information. The processor of the management server may be operable to obtain the asset information for the replacement graphic asset. The processor of the management server may be operable to control the communicator to communicate the asset information for the replacement graphic asset to the user electronic device.

The management server may be operable to receive graphic assets from other entities such as users or content managers. The management server may provide a website user interface which may be used by the other entities to upload graphic assets to the management server. The management server may be operable to store the received graphic assets in a memory or storage of the management server or another data store associated with the management server. The location where the graphic assets are stored may be referred to as a graphic asset vault. The management server may thus act as a library comprising a number of different graphic assets which may be applied to digitised transaction cards according to graphic asset preference information. The management server may also comprise a library of digitised transaction card information such as identifiers for the digitised transaction cards.

According to an aspect of the present invention there is provided a method performed by a system. The system comprising a user electronic device comprising a communicator, and a processor communicatively coupled to the communicator. The processor is operable to execute a digital wallet application. The digital wallet application, when executed, is arranged to display a graphic asset associated with a digitised transaction card. The method comprises obtaining graphic asset preference information in relation to the digitised transaction card. The method comprises controlling the communicator to communicate the graphic asset preference information to a management server. The method comprises controlling the communicator to receive asset information for a replacement graphic asset, the replacement graphic asset being determined according to the graphic asset preference information. The method comprises replacing the graphic asset associated with the digitised transaction card with the replacement graphic asset according to the communicated asset information such that the digital wallet application, when executed, is arranged to display the replacement graphic asset associated with the digitised transaction card.

The asset information may be received from the management server.

The asset information may be received from a transaction card server.

According to an aspect of the present invention, there is provided a user electronic device suitable for use with the system according to aspects of the present invention. The user electronic device comprises a communicator, and a processor communicatively coupled to the communicator. The processor is operable to execute a digital wallet application. The digital wallet application, when executed, is arranged to display a graphic asset associated with a digitised transaction card. The processor of the user electronic device is operable to obtain graphic asset preference information in relation to the digitised transaction card. The processor of the user electronic device is operable to control the communicator to communicate the graphic asset preference information to a management server. The processor of the user electronic device is operable to control the communicator to receive asset information for a replacement graphic asset. The replacement graphic asset is determined according to the graphic asset preference information. The processor of the user electronic device is operable to replace the graphic asset associated with the digitised transaction card with the replacement graphic asset according to the communicated asset information such that the digital wallet application, when executed, is arranged to display the replacement graphic asset associated with the digitised transaction card.

The asset information may be received from the management server.

The asset information may be received from a transaction card server.

According to an aspect of the present invention, there is provided a system. The system comprises a user electronic device. The user electronic device comprises a communicator, and a processor communicatively coupled to the communicator. The processor is operable to execute a digital wallet application. The digital wallet application, when executed, is arranged to display a graphic asset associated with a digitised transaction card. The system comprises a management server. The management server comprises a communicator in communication with the communicator of the user electronic device, and a processor communicatively coupled to the communicator. The processor of the management server is operable to control the communicator to communicate asset information for a plurality of replacement graphic assets to a transaction card server. The processor of the management server is operable to control the communicator to receive, from the transaction card server, an identifier for each of the communicated replacement graphic assets. The processor of the management server is operable to store the identifiers for the replacement graphic assets in a data store. The processor of the user electronic device is operable to obtain graphic asset preference information in relation to the digitised transaction card. The processor of the user electronic device is operable to control the communicator to communicate the graphic asset preference information to a management server. The processor of the management server is operable to select one of the replacement graphic assets according to the received graphic asset preference information. The processor of the management server is operable to obtain the identifier for the selected replacement graphic asset from the data store. The processor of the management server is operable to control the communicator to communicate the identifier to the transaction card server so that the transaction card server is able to control the user electronic device to replace the graphic asset associated with the digitised transaction card with the replacement graphic asset according to the asset information such that the digital wallet application, when executed, is arranged to display the replacement graphic asset associated with the digitised transaction card.

The system may comprise the transaction card server.

Generally, aspects of the present invention provide a system and/or method for managing the graphic assets applied to transaction card representations within a digital wallet application. The system may comprise an electronic device such as a mobile telecommunications device that is associated with an end-user, i.e. a user electronic device. The electronic device may comprise an image sensor such as camera. The electronic device may comprise a processor for processing image data from the sensor and for processing user preference information input to the electronic device by the end user. The electronic device may comprise a memory for storing processed image and metadata. The electronic device may comprise a telecommunications module operable to download a consumer application. Preferably, the telecommunication module is a wireless telecommunications module. The system may comprise a management server configured to receive information from the electronic device relating to graphic assets preferences of the end-user and to communicate with a payment service provider to implement changes in the graphic assets of a digital wallet application stored on the device.

The consumer application may comprise at least one of: a user interface; a registration interface; a ‘wallet’ interface of transaction card entries; a transaction card identification software; a library of available graphics for use on transaction card representations in the digital wallet application; and a preferences interface for making selections.

The electronic device may be arranged to execute the downloaded application to control the electronic device to carry out at least one function, method and/or operation as per the embodiments described herein.

Moreover, the electronic device may be arranged to execute the downloaded consumer application to control the electronic device to perform a set of actions, the set of actions comprising at least one of: identifying the physical data-bearing media (in this case a physical transaction card) using embedded software; identifying a user's card graphics preferences; updating the graphics on a transaction card representation to be reflected in a digital wallet application; applying multiple graphics preferences to a single transaction card; creating rules for when graphics updates are triggered.

Ideally, the electronic device is arranged to associate with a user account the data extracted from a set of data-bearing media. Advantageously, this enables transaction cards and a collection of user-selected graphics to be linked to the same user account, which thereby enables user-selected graphical differentiation in the digital wallet.

The application may be sourced from an application store and/or content provider. For example, the content provider may comprise the Apple® Appstore®. The content provider may comprise a cloud computing provider.

The system may further comprise at least one of: a management server; a registration module; an encryption module; a decryption module; a transaction card provider; an application API; a partner API. The management server may comprise a management database comprising at least one of: a library of graphic assets for transaction cards; and transaction card truncated PAN and Token data.

According to an aspect of the invention, the system may be configured to perform a method to update the graphics displayed in a user's digital wallet application. The method may comprise a combination of a plurality of the following steps: enrolling, via consumer application, a transaction card on an electronic device; sending, via the electronic device, transaction card data to a payment service provider; storing, at the payment service provider, the transaction card data in a database; receiving, at the electronic device a token and other relevant transaction card data from the payment service provider; communicating, by the electronic device, token and transaction card data communicated to a management server via a communications network; persisting the token and transaction card data in a database of the management server; delivering pre-approved graphics from the management server to a consumer application operating on the electronic device; receiving, at the management server from the electronic device, one or more user selected graphics and/or user preference information for one or more enrolled transaction card; persisting the user selection and/or preference information in a database of the management server; sending an update notification from the management server to the payment service provider to update the card meta data relating to graphic assets for the one or more enrolled transaction cards; updating the graphic assets associated with the enrolled transaction card in the transaction card server graphic assets vault; accessing the graphic assets vault using the digital wallet application; and updating the graphics displayed for the representation of at least one enrolled transaction card.

A method and system of the kind described herein are particularly advantageous as it allows users to update card graphics information where they would not have previously been able to. Ordinarily, the legacy systems of payment service providers that are required to interact with digital wallet applications are unable to provide graphics image data based upon PANs as all card data is stored based on BINs, or Bank Identification Numbers. The invention makes use of the fact that the transaction card server graphic assets vaults are accessible via an API that accepts information relating to PAN and metadata including image details, without requiring re-design of the entire system to accommodate user preference in image data.

It will be understood that features, functions and advantages of this aspect of the present invention may be combined or substituted where context allows. Furthermore, features herein may themselves constitute further aspects of the invention. For example, the application of multiple user-selected graphics to a transaction card presented in a digital wallet application.

According to another aspect of the invention, there is provided a computer-implemented method of transferring a digital asset from a first user to a second user. The method comprises authenticating the first user as the owner of the digital asset by inspecting a transaction database. The method comprises transferring the digital asset from the first user to the second user by: updating the transaction database so as to identify the second user as the owner of the digital asset; and providing a graphic asset associated with the digital asset to a user electronic device of the second user.

The present invention thus enables a digital asset to be transferred from a first user to a second user. The digital asset may be loyalty points accrued by one of the users. The present invention enables the user to transfer these accrued loyalty points to another user. This transfer is performed using a process which authenticates the user as the correct owner of the loyalty points, and which transfers a graphic asset to the user electronic device of the second user which desires the loyalty points.

The method may comprise updating a digital wallet application of the user electronic device of the second user using the provided graphic asset so that the digital asset is associated with a digitised transaction card of the digital wallet application.

The user electronic device of the second user may comprise a communicator, and a processor communicatively coupled to the communicator. The processor may be operable to execute a digital wallet application. The user electronic device may be a user electronic device as described above in relation to other aspects of the present invention. The communicator may be operable to receive the graphic asset associated with the digital asset.

Updating the digital wallet application may comprise adding a digitised transaction card to the digital wallet application and associating the digitised transaction card with the provided graphic asset. The properties of the digitised transaction card may be determined at least in part by the provided graphic asset. This may mean that a processor of the user electronic device is operable to add a new digitised transaction card for the digital asset into the digital wallet application. The graphic asset may be associated with the new digitised transaction card such that the digital wallet application, when executed, is arranged to display the graphic asset associated with the digitised transaction card.

Updating the digital wallet application may comprise updating an existing digitised transaction card in the digital wallet application by replacing the existing graphic asset associated with the digitised transaction card with the provided graphic asset. This may mean that the processor of the user electronic device is operable to replace the graphic asset of an existing digitised transaction card with the provided graphic asset associated with the digital asset. The digital wallet application, when executed, may be arranged to display the provided graphic asset associated with the existing digitised transaction card. In this way, the existing digitised transaction card may be linked with the digital asset and the graphic asset may be changed to indicate this association with the digital asset. For example, when the digital asset relates to loyalty points, subsequent use of the digitised transaction card may generate additional loyalty points under a loyalty point scheme.

Transferring the digital asset may further comprises providing metadata associated with the graphic asset. The metadata may comprise an identifier for the graphic asset. The identifier may link the graphic asset to a record of the digital asset in the transaction database. The record may comprise at least one of the value of the digital asset and the recorded owner of the digital asset. For example, when the digital asset relates to loyalty points, the record may comprise the number of loyalty points, and the recorded owner for the loyalty points.

The first user may be associated with a user electronic device comprising a digital wallet application. The digital wallet application may comprise a digitised transaction card associated with a graphic asset and a digital asset.

In response to receiving a request for the first user to transfer the digital asset to the second user, the method may comprise disassociating the graphic asset from the digitised transaction card.

In response to receiving a request for the first user to transfer a part of the digital asset to the second user, the method may comprise obtaining another graphic asset. The method may comprise associating the another graphic asset with the part of the digital asset. The method may comprise updating the transaction database so as to identify the second user as the owner of the part of the digital asset. The method may comprise providing the another graphic asset to the user electronic device of the second user. As an example, the first user may have a graphic asset in their digital wallet which has 100 loyalty points associated with it. The first user may wish to transfer only a portion of these loyalty points (e.g. 50). The present invention enables this to happen by obtaining a new graphic asset, and associating the new graphic asset with the 50 points to be traded. The new graphic asset is sent over to the buyer, or person swapping the digital asset, and the original graphic asset will remain in the digital wallet application of the first user but will now only be associated with 50 points. This change in value of digital asset associated with the digital assets may be recorded in the transaction database.

The digital asset may be transferred in response to receiving a request to transfer the digital asset. The request may be provided in response to the electronic device of the second user receiving information regarding the digital asset of the first user. The information regarding the digital asset of the first user may be provided to a plurality of electronic devices associated with a plurality of users. The information regarding the digital asset may be provided by the first user in response to a request from the second user or another user.

The transfer of the digital asset from the first user to the second user may be in exchange for a second digital asset from the second user.

The method may further comprise authenticating the second user as the owner of the second digital asset by inspecting a transaction database. The method may further comprise transferring the second digital asset from the second user to the first user by: updating the transaction database so as to identify the first user as the owner of the second digital asset; and providing a second graphic asset to a user electronic device of the first user. The metadata may comprise information identifying the nature of the second digital asset.

The graphic asset may be provided by a user electronic device of the first user. The graphic asset may be provided by a management server. The management server may be a management server as described in other aspects of the present invention. The mechanism by which the graphic asset is provided may be the same as described in other aspects of the present invention. The graphic asset may be provided by a transaction card server. The transaction card server may be a transaction card server as described in other aspects of the present invention. The mechanism by which the graphic asset is provided may be the same as described in other aspects of the present invention.

The providing of the graphic asset may be triggered by interaction between a user electronic device of the first user and the user electronic device of the second user. For example, the user electronic devices of the first and second users may communicate over a network, such as a wide area network, a local area network, a personal area network, or a near-me-area network. The communication may be via Bluetooth®. The user electronic devices may communicate using NFC. One of the user electronic devices may transmit a code such as a QR code for triggering the providing of the graphic asset.

In accordance with the present invention, loyalty schemes may be able to associate an incentive with a particular graphic asset. A user wishing to join the loyalty scheme may obtain the particular graphic asset and link the graphic asset to one of their digitised transaction cards in their digital wallet application using the approaches described above, for example. In other words, the ability to customise and assign graphic assets for digitised transaction cards in a digital wallet application provides the added benefit of enabling digital assets such as loyalty points to be swapped or traded by users. In more detail, the loyalty schemes may accrue value, or points, and consumers may be able to trade or swap for other schemes by transferring the graphic (points traders), optionally along with the associated metadata, with accrued value attached to them. This could be a direct trade between two users. The trade could also be provided in an open marketplace, where users can advertise requirements for digital assets (e.g. points), or advertise digital assets (e.g. points) they are willing to release, possibly for other digital assets (e.g. points associated with a different loyalty scheme). The users may exchange the digital assets in person by sharing the graphic assets. It may also be possible to trade the digital assets through a consumer application on a user electronic device or via a website. This may be beneficial when the users are not within the same location.

A consumer application may be provided, which may be on a user electronic device, which is used to view and manage the digital assets and the trades thereof. The validation of trades, redemption and accrual of points for specific schemes, may be managed and secured using a transaction database which may involve the user of a distributed ledger.

Generally, aspects of the present invention involve the digital asset being authenticated (such as by being registered on the distributed ledger), the ownership assigned (which may be registered on the distributed ledger), and then traded (which may involve registering the owner in the distributed ledger). The present invention uses graphic assets as the means of validation and consumption, and the distributed ledger acts as the trading and validation network.

As trades happen, the transaction database may be able to validate ownership, and transfer over to new owner near instantly, and in real time. The ownership of the digital asset will be understood by the scheme (e.g. loyalty scheme) providers, so that the new owner is able to redeem their digital asset when suitable. The relative trades of digital assets may be recorded in a data store, which will allow scheme providers to understand relative value and engagement of their scheme. The trading may happen on an open market, and the value of the trades will be decided peer to peer. This may help loyalty scheme providers, merchants, banks, and payment platforms to understand relative value of the points that are issued, and how engaged consumers are with the scheme.

According to an aspect of the present invention, there is provided a computer program comprising instructions which when executed by a computer cause the computer to perform the method of transferring a digital asset from a first user to a second user. The method comprises authenticating the first user as the owner of the digital asset by inspecting a transaction database. The method comprises transferring the digital asset from the first user to the second user by updating the transaction database so as to identify the second user as the owner of the digital asset; and by providing a graphic asset associated with the digital asset to a user electronic device of the second user.

According to an aspect of the present invention, there is provided a computerised system for transferring a digital asset from a first user to a second user. The system being arranged to authenticate the first user as the owner of the digital asset by inspecting a transaction database. The system being further arranged to transfer the digital asset from the first user to the second user by: updating the transaction database so as to identify the second user as the owner of the digital asset; and providing a graphic asset associated with the digital asset to an electronic device of the second user.

For a better understanding of the invention, and to show how embodiments of the same may be carried into effect, reference will now be made, by way of example only, to the accompanying diagrammatic drawings in which:

FIG. 1A shows a digital wallet application according to an existing implementation;

FIG. 1B shows a schematic view of a system according to an existing implementation;

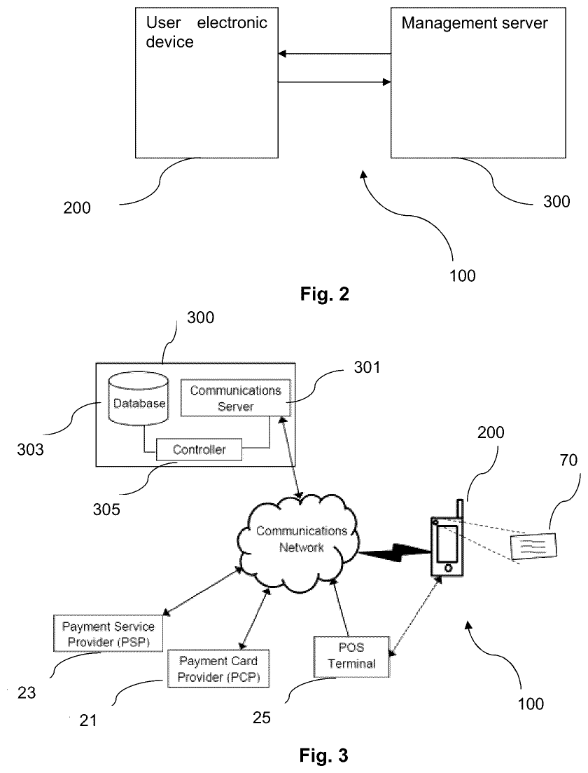

FIG. 2 shows an example system according to aspects of the present invention;

FIG. 3 shows an example system according to aspects of the present invention;

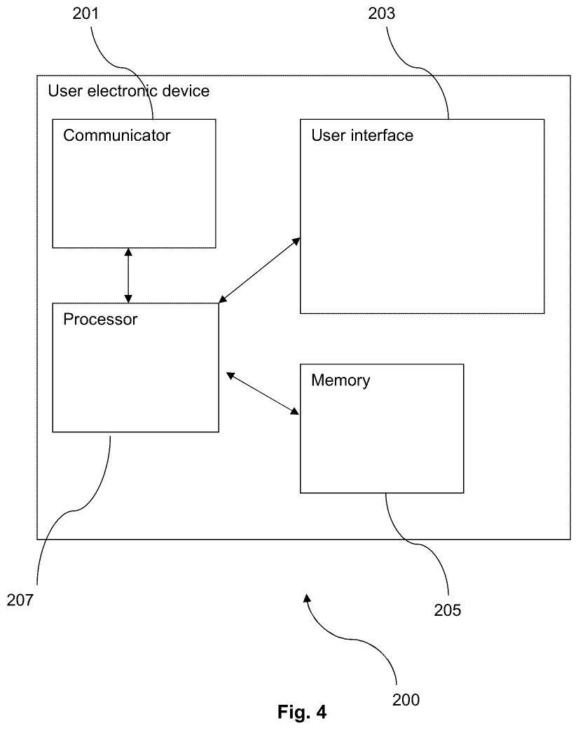

FIG. 4 shows an example user electronic device according to aspects of the present invention;

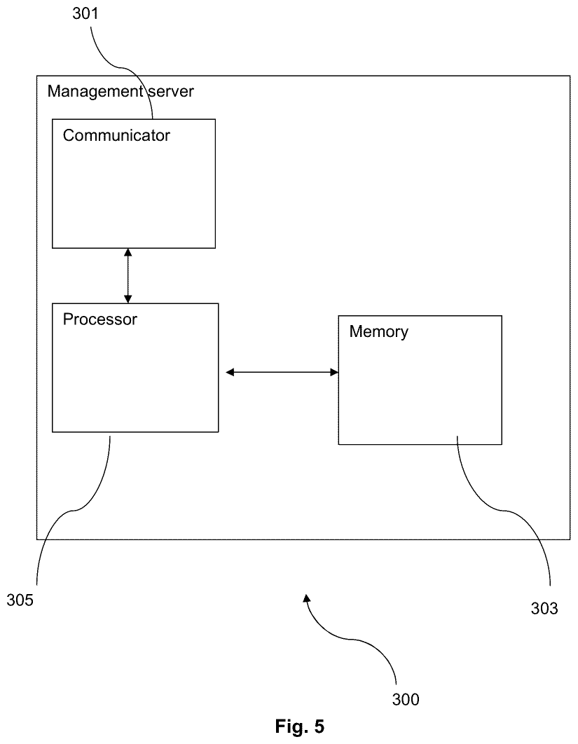

FIG. 5 shows an example management server according to aspects of the present invention;

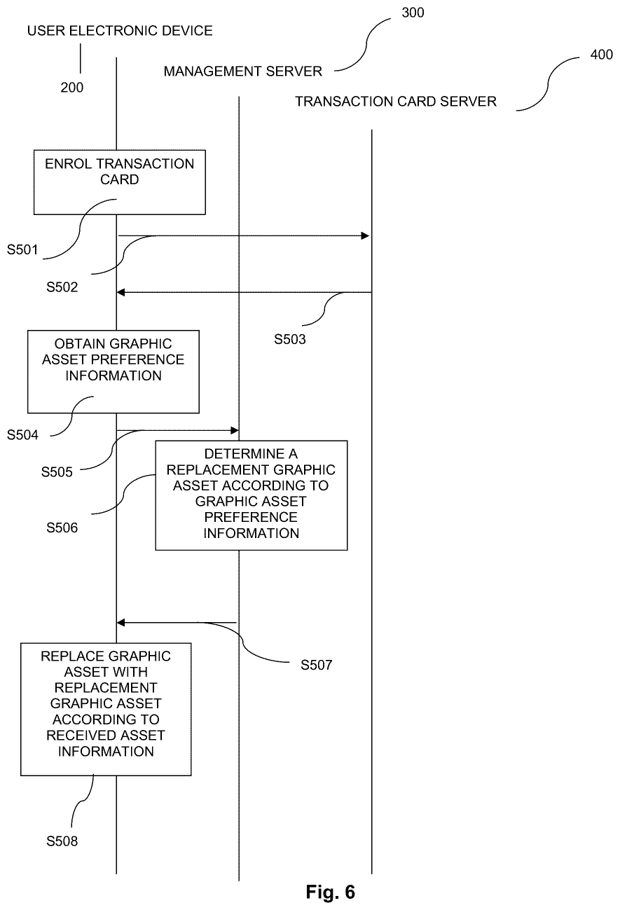

FIG. 6 shows an example signal flow diagram according to aspects of the present invention;

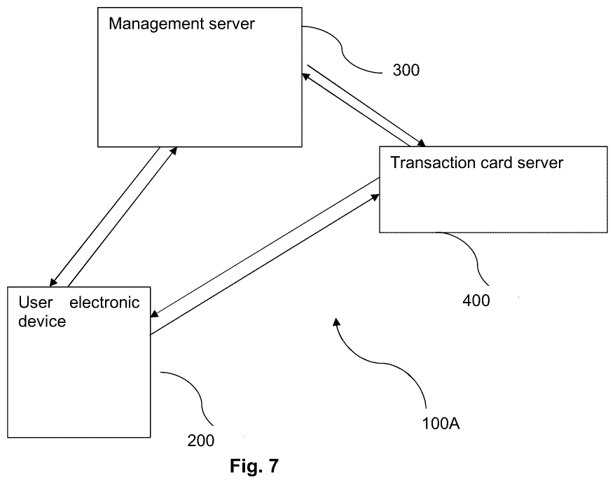

FIG. 7 shows an example system according to aspects of the present invention;

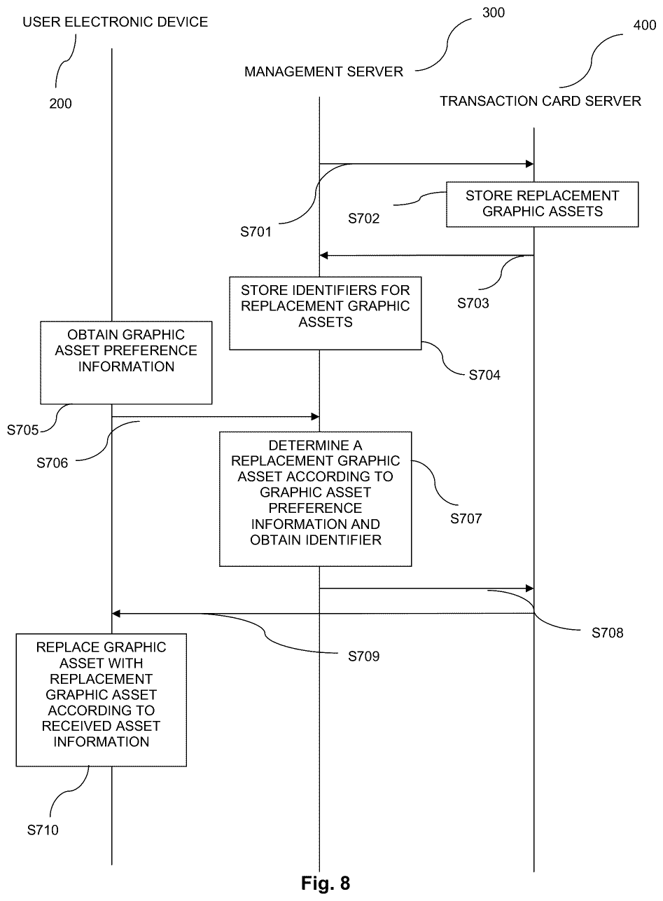

FIG. 8 shows an example signal flow diagram according to aspects of the present invention;

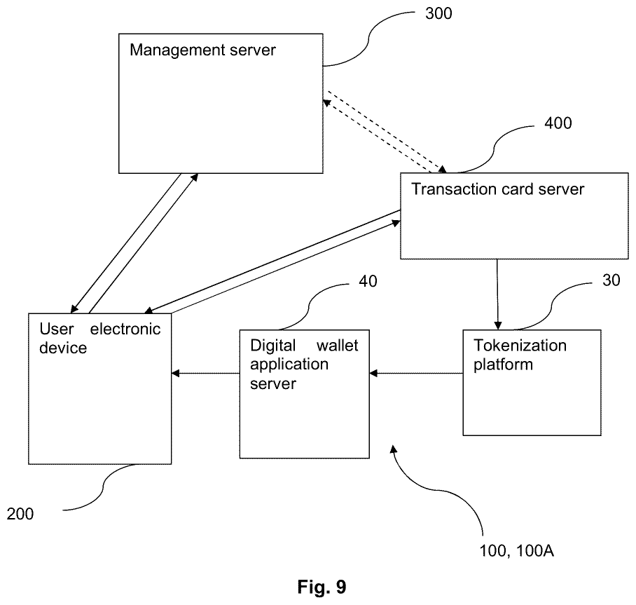

FIG. 9 shows an example system according to aspects of the present invention; and

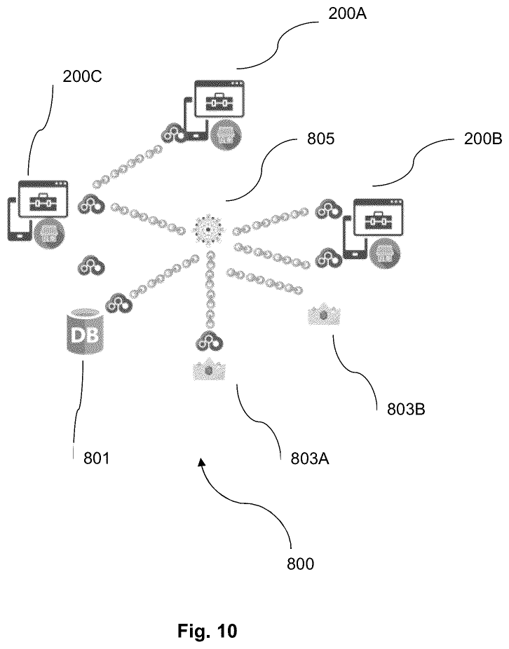

FIG. 10 shows an example system according to aspects of the present invention.

Referring to FIG. 2, there is shown a system 100 according to the present invention. The system 100 comprises a user electronic device 200 and a management server 300. The user electronic device 200 and management server 300 are communicatively coupled to one another, e.g. via a wireless communication connection, such that they may send and receive data from one another.

The system 100 is configured to provide improved graphics for transaction card representations in a digital wallet according to an embodiment of the present invention.

The user electronic device 200 acts as a digital wallet. In particular, a digital wallet application and consumer application are both installed on the user electronic device 200, and are operable in combination to allow personalisation or updating of existing graphic assets associated with digitised transaction cards enrolled in the digital wallet application. The digital wallet and consumer applications are downloadable from an application store and/or content provider. For example, the content provider may comprise the Apple® Appstore® or Google® Play®. The consumer application may be incorporated into another application on the device. The functionality of the consumer application may be provided as a software developer's kit (SDK) so that the consumer application may be incorporated into another application such as a banking application.

FIG. 3 illustrates another representation of a system 100 according to the present invention and configured to provide improved graphics for transaction card representations in a digital wallet. The system 100 comprises the user electronic device 200 and management server 300 also shown in FIG. 2. The system shown in FIG. 3 uses a communications network, such as a wide-area network, and in particular the Internet for example, which connects the various parties involved in the system and provides network infrastructure for the exchange of data. The user electronic device 200 is connected to the communications network in order to upload data for processing to the management server 300. The consumer application comprises an application interface that is used to gather data from the user, and to display data sent to the application by the management server 300 via a communications network. For example, the consumer application may gather transaction card information by capturing an image of a physical transaction card 70 using the device camera as shown in FIG. 3.

Data input to the consumer application by the user can be uploaded via the communications network to a centralized hub (e.g. the management server 300), where it can be managed and processed. The management server 300 may receive data sent via the communications network and provide data to other components connected to the communications network. The management server 300 comprises a communicator 301 shown in the form of a communications server, a processor/controller 305 and a memory/database 303. Data is received and processed at the management server 300 by the communications server 301, which is operatively coupled with the controller 305. The controller 305, in turn, is operatively coupled with the database 303. Data that is received by management server 300, or data that is of use for the operation of the management server 300, may be stored in the database 303. The management server 300 is external to the consumer application and acts as an on demand service.

In order to perform transactions, the user electronic device is configured to communicate with a point-of-sale (POS) terminal 25 associated with a particular merchant using NFC or other short-range wireless communication protocol. This communication is depicted by a dotted line in FIG. 3. FIG. 3 further shows at least one transaction card provider (PCP) 21 and at least one transaction card server, which is identified as a payment service provider (PSP) 23. The components are connected via the communications network.

Referring to FIG. 4, there is shown a simplified schematic diagram of an example user electronic device 200 in accordance with the present invention. The user electronic device 200 comprises a communicator 201, a user interface 203, a memory/data store 205, and a processor 207. The memory 205 has stored thereon a digital wallet application. The processor 207 is communicatively coupled to the communicator 201, user interface 203, and memory 205.

The user interface 203 may comprise or be associated with a display. The user electronic device 200 may also comprise a camera. The communicator 201 is operable to facilitate exchange of data with other processing elements shown in FIGS. 2 and 3 via the communications network, or with the POS terminal via NFC. The user electronic device 200 may also operate a consumer application stored within the memory/data store 205, and is able to be run on command by the processor 207 in the conventional manner. The user interface 203 of the user electronic device 200 may be integral with a display of the user electronic device 200, and may be a presence sensitive display such as a touch screen in this embodiment. Typically the user electronic device 200 is a smartphone or tablet.

The digital wallet application comprises a digitised transaction card. The digital wallet application also comprises a graphic asset associated with the digitised transaction card. The digital wallet application, when executed by the user electronic device 200 is arranged to display the graphic asset associated with the digitised transaction card. For example, the user electronic device 200 may be arranged to display the graphic asset associated with digitised transaction card in the manner shown in FIG. 1A.

An object of the present invention is to enable the graphic asset associated with the digitised transaction card to be changed, e.g. to suit a user preference. In conventional digital wallet application architectures this is not possible, as the graphic assets are controlled centrally by a transaction card server, which means that all users will use the same graphic asset for the same type of digitised transaction card (e.g. from a particular bank). This arrangement makes it challenging for a user to select their desired digitised transaction card when using the digital wallet application. The present invention is thus concerned with providing technical means to enable an improved man machine interface for allowing a user to select a desired digitised transaction card.

In accordance with the present invention, the processor 207 of the user electronic device 200 obtains graphic asset preference information in relation to the digitised transaction card.

In one example of this, the user electronic device 200 receives a user command for selecting graphic asset preference information. The user command may be provided by user input via the user interface 203 of the user electronic device 200. The user input may be provided via voice control.

In one example of this, the processor 207 controls the user interface 203 to display one or a plurality of replacement graphic assets for the digitised transaction cards for selection by the user. The user may then provide a user input for selecting their desired replacement graphic asset. The user input may be via a touchscreen or via voice controls. In this example, the processor 207 of the user electronic device is operable to control the user interface 203 to display a representation of a replacement graphic asset for selection by the user. Representations of a plurality of other, different, replacement graphic assets may also be displayed on the user interface 203 for selection by the user. The representations of the replacement graphic assets may be displayed by the consumer application.

In another example of this, the processor 207 may determine the graphic asset preference information according to a location of the user electronic device 200. The location of the user electronic device 200 may be determined by a navigation sensor (such as a satellite navigation sensor) or the user electronic device 200. For example, the user may have a digitised transaction card which is beneficial to use when in a particular country. When the user electronic device 200 is determined to be within the particular country, the graphic asset preference information may indicate a preference for a graphic asset that highlights that the digitised transaction card should be used for transactions rather than other digitised transaction cards within the digital wallet application.

In another example of this, the processor 207 may determine the graphic asset preference information according to the current date and/or time. For example, the user may have a digitised transaction card which is beneficial to use at a certain date and/or time. The graphic asset preference information may indicate a preference for a graphic asset that highlights the date and/or time when it is beneficial to use the digitised transaction card. For example, the graphic asset of the digitised transaction card may change according to the current date/time.

The processor 207 of the user electronic device 200 controls the communicator 201 to communicate the graphic asset preference information to the management server 300.

The processor 207 of the user electronic device 200 controls the communicator 201 to receive, from the management server 300, asset information for a replacement graphic asset. The replacement graphic asset is determined according to the graphic asset preference information.

For example, if the graphic asset preference information communicated to the management server 300 indicates a preference for a representation of a graphic asset selected by a user, the asset information for the replacement graphic asset is determined according to this user preference.

In one example, the asset information comprises a storage location for the replacement graphic asset. In this example, the processor 207 of the user electronic device 200 is operable to obtain the replacement graphic asset from the storage location. The storage location may be in the form of a download link, e.g. is in the form of a uniform resource locator, URL. The storage location may be in a data store of the management server 300.

In another example, the asset information comprises the replacement graphic asset. That is, the user electronic device 200 directly receives a copy of the replacement graphic asset from the management server 300.

The processor 207 of the user electronic device 200 replaces the graphic asset associated with the digitised transaction card with the replacement graphic asset according to the communicated asset information such that the digital wallet application, when executed by the user electronic device 200, is arranged to display the replacement graphic asset associated with the digitised transaction card. In this way, the existing graphic asset for the digitised transaction card is replaced with a new graphic asset determined according to the graphic asset preference information.

Referring to FIG. 5, there is shown a simplified schematic diagram of an example management server 300 in accordance with the present invention. The management server 300 comprises a communicator 301, a memory 303 and a processor 305. The communicator 301 is in communication with the communicator 201 (FIG. 4) of the user electronic device 200. The processor 305 is communicatively coupled to the communicator 301 and memory 303.

The processor 305 of the management server 300 controls the communicator 301 to receive the graphic asset preference information from the user electronic device 200 (via the communicator 201). The processor 305 controls the communicator 301 to determine a replacement graphic asset according to the received graphic asset preference information. The processor 305 obtains the asset information for the replacement graphic asset, and controls the communicator 301 to communicate the asset information for the replacement graphic asset to the user electronic device 200.

The management server 300 may further comprise a user accounts module which is associated with a user accounts database. Together, the processor 305 and user accounts module are configured to register individual users and their associated devices, to process the preferences selected by a user using the consumer application, to identify the user information initially, to pass the information to the user accounts database and to build a profile of the user based upon preference information.

The memory 303/database/data store of or associated with the management server 300 may comprise two separate sections: a graphic assets vault and the user accounts database. The graphic assets vault contains information relating to graphic assets that may be selected by a user for display in a digital wallet. The user accounts database contains specific information relating to each user such as the digitised transaction cards and/or registered tokens for the digitised transaction cards, a user profile and enrolment information and the user's preference information.

The communicator 301 may also comprise or be associated with an encryption module for encrypting data before it is communicated, a decryption module for decrypting encrypted data communicated to the management server 300, and a notification module for generating signals and/or commands to be communicated to the electronic device.

Referring to FIG. 6, there is shown a signal flow diagram for an example process in accordance with the aspects of the invention.

In step S501 the user of the user electronic device 200 enrols a transaction card.

In step S502 identification information for the transaction card is transmitted to a transaction card server 400.

In step S503, a reference identifier for the transaction card and a standard graphic asset for the transaction card is transmitted to the user electronic device 200.

In step S504, the user electronic device 200 obtains graphic asset preference information.

In step S505, the graphic asset preference information is transmitted to the management server 300.

In step S506, the management server 300 determines a replacement graphic asset according to the received graphic asset preference information.

In step S507, asset information for the replacement graphic asset is transmitted to the user electronic device 200.

In step S508, the user electronic device 200 replaces the current graphic asset with the replacement graphic asset according to the received asset information.

Referring to FIG. 7, there is shown another example system 100A according to aspects of the present invention. The system 100A achieves the same objective as the system 100. That is, the system 100A also replaces a graphic asset in a digital wallet application on the user electronic device 200. The user electronic device 200 and the management server 300 in the system 100A may be the same/provide the same functionality as the user electronic device 200 and the management server 300 of the system 100.

Unlike the system 100, the system 100A communicates the asset information for the replacement graphic asset via the transaction card server 400. This approach is particularly suited for retrofitting the system into existing digital wallet application architectures such as the one shown in FIG. 1B where the digital wallet application/digital wallet application server 40 (FIG. 1B) may not allow an external management server 300 to directly communicate with the digital wallet application to replace graphic assets.

Referring to FIG. 8, there is shown a signal flow diagram for an example process in accordance with the aspects of the invention

In step S701, the management server 300 transmits asset information for a plurality of replacement graphic assets to the transaction card server 400.

In step S702, the transaction card server 400 stores the replacement graphic assets.

In step S703, the transaction card server transmits an identifier for each of the replacement graphic assets to the management server 300.

In step S704, the management server 300 stores the identifiers in memory/data store.

In step S705, the user electronic device 200 obtains graphic asset preference information.

In step S706, the graphic asset preference information is transmitted to the management server 300.

In step S707, the management server 300 determines a replacement graphic asset according to the received graphic asset preference information and obtains the stored identifier for the replacement graphic asset.

In step S708, the management server 300 transmits the obtained identifier to the transaction card server 400.

In step S709, the digitised transaction management server 400 transmits asset information for the replacement graphic asset to the user electronic device 200. Significantly, the digitised transaction management server 400 is transmitting the asset information in the same way as the standard graphic assets are provided to the digital wallet application. In this way, the graphic asset in the digital wallet application is able to replaced without requiring any, or at least minimal, redesign of an existing digital wallet application. The asset information may be transmitted via the tokenization platform 30 and/or the digital wallet application server 40.

In step S710, the user electronic device 200 replaces the current graphic asset with the replacement graphic asset according to the received asset information.

Referring to FIG. 9, there is shown another example of a system 100, 100A in accordance with the present invention. The system 100, 100A comprises the user electronic device 200, the management server 300, the transaction card server 400, the tokenization platform 30, and the digital wallet application server 40.

The management server 300 may provide asset information for a replacement graphic asset directly to the user electronic device (e.g. as per FIG. 6) or may provide the asset information via the transaction card server 400 (e.g. as per FIG. 8).

A general example operation of the system 100, 100A will now be described.

The initial process of downloading the application, installation on the user electronic device 200 and registration of a user will be described. Following this, the process relating to the user's image preferences being displayed in the digital wallet application will be described.

The user initially downloads the consumer application to their user electronic device 200 and installs the consumer application to allow the consumer application to interact with and control the device 200. The consumer application is stored in the device memory/database and may be sourced from an application store and/or content provider. For example, the content provider may comprise the Apple® Appstore® and/or may comprise a cloud computing provider.

After installation of the application, a user may register personal details using the consumer application interface. These details are used for identification purposes and for subsequent authentication requests. The consumer application encrypts and communicates the user details to the management server 300, which receives the details at communicator 301 (FIG. 5) via an application programming interface (API). The communicator 301 then decrypts the details and passes them to the processor 305 (FIG. 5) to allow a user profile to be created in the user accounts database. Although only a single user electronic device 200 is depicted here, it will be appreciated that more than one user electronic device 200 will be able to communicate with the management server 300 via the communications network at any time.

As the management server 300 is an on-demand service, the user electronic device 200 requires a connection to the communications network, such as an internet connection, for the user to be able to interact fully with the consumer application. Where a user electronic device 200 cannot connect to the management server 300, then the application is still be able to perform much of its functionality with only locally cached media. It is noted however that changes to preferences are not saved to the relevant database and so these changes do not persist in such a situation.

When a connection to the communications network and connection to the management server 300 are established, the details are encrypted using an encryption module (not shown) and persisted in the user accounts database.

The process of enrolment of a user, and the process relating to the user's image preferences will now be described.

Having registered with the service, the user may enrol at least one transaction card used in their existing digital wallet application via the consumer application or directly from the digital wallet application if the consumer application is integrated with the digital wallet application. The consumer application may have the functionality to enrol the transaction card in the digital wallet application simultaneously and automatically.

To enrol the at least one transaction card, the user is typically required to input at least a Primary Account Number (PAN) for the card, and optionally may input an expiry date and security code. The encrypted card information is securely transferred from the device 200 to the tokenization platform 30 via the communications network. The transfer of transaction card data to may be via the management server 300, although the management server 300 is typically not able to decrypt the encrypted card information, as this information may only be decrypted by the tokenization platform 30. The transaction card data may be transferred directly from the user electronic device 200 to the tokenization platform 30, or may be transferred via the transaction card server 400. The tokenization platform 30 may be part of or may be associated with the transaction card server 400.

The tokenization platform 30 decrypts the PAN and any other card information from which it generates a card identifier (CID). The PAN and other card information is then stored in a card data vault associated with the tokenization platform 30. The CID is a non-sensitive data equivalent used to refer to the card so that reference can be made to it without any sensitive information being transferred via non-encrypted communications. The tokenization platform 30/transaction card server 400 encrypts and securely returns the CID to the management server 300 and/or the user electronic device 200.

The CID, at least, is subsequently transferred from the consumer application operating on the user electronic device 200 to the management server 300. At this point, the consumer application may communicate additional data such as user-specific data or assets, although it will be appreciated that this information may be communicated to the management server by the electronic device at any time.

The management server 300 confirms to the user electronic device 200 that the data has been received. A confirmation may be communicated to the user.

Once the management server 300 has received the CID at its communicator 301, the user accounts module of the management server 300 is configured to store the CID in the user accounts database for subsequent use.

The card enrolment process is then complete, and the user is prompted to either enrol more cards, in which case the process repeats until the user has finished enrolling transaction cards, or to specify graphic asset preference data for their enrolled transaction card or cards. The user may specify graphic asset preference data based upon graphic assets stored in the graphic assets vault of the management server 300, or may specify images stored on the user electronic device 200. Other approaches for specifying image/graphic asset preferences are described above. In some examples, the graphic asset preferences are not determined by the user, but are determined based on factors such as the location of the user electronic device 200, or the current date/time.

The user electronic device 200 encrypts the preference information before communicating it to the management server 300, where it is passed from the communicator 301 to the processor 305. The processor 305 utilizes the preference information to update the user's profile in the user accounts database and to access the relevant asset information that corresponds to the user's preference in the graphics assets vault. If this is successful, the communicator 301 again issues a confirmatory response to the electronic device.

The asset information retrieved from the graphics assets vault may be in the form of complete image data, or may comprise an asset id number to allow the device to retrieve the correct asset using the id number when required.

Having retrieved the asset information from the graphics asset vault, the controller passes the asset information and CID to the communicator 301. The communicator 301 transfers the asset information and CID to the tokenization platform 30 (e.g. via the transaction card server 400). The tokenization platform 30 receives the CID and graphics data, and accesses the PAN to which the CID relates. The tokenization platform 30 returns a success or failure message to the management server 300. In another example, the communicator 301 communicates the asset information directly to the user electronic device 200, thereby bypassing the tokenization platform 30.

The tokenization platform 30 then passes the PAN and graphics data to a controller of the transaction card server 400, which identifies the transaction card that corresponds to the PAN and the current graphics data in a transaction card server 400 graphic assets vault. The transaction card server 400 graphic assets vault data for that card is then overwritten by the controller using the PAN and new graphics data.

Then, when the digital wallet next communicates with the transaction card server 400, either when the digital wallet application is opened or at a predetermined point, the transaction card server 400 communicates asset information to the user electronic device 200. The asset information may be image data, a location within the transaction card server 400 graphic assets vault from which the digital wallet application is required to download the information, a location within the graphic assets vault of the management server 300, or may even be or identify an image stored by the consumer application in the device 200 database. The user will see the new digitised transaction card graphic asset when they access the card in the digital wallet application.

In summary, in this example implementation, the following steps may be considered to be performed;

1. Transaction card enrolled via consumer application on electronic device.

2. PAN and transaction card data sent to tokenization platform of transaction card server via a secure, restful API.

3. Card details stored in Card Data Vault associated with tokenization platform.

4. Token (CID) and transaction card data returned to user electronic device 200 in an https response.

5. Token and payment card data communicated to management server 300 via communications network.

6. Token and transaction card data persisted in database of management server.

7. Pre-approved graphics delivered to consumer application by secure restful API from graphics assets vault of the management server.

8. User selects one or more graphics and specifies any other preference information for one or more enrolled transaction cards.

9. User selection and preference information communicated to management server.

10. User selection and preference information persisted in database of management server.

11. Management server sends a Card Meta Data Update Notification including token and graphic asset information to the tokenization platform 30 (also referred to as proxy pass-through service) to update the graphics data associated with the transaction card within the transaction card server 400 graphics image vault.

12. The token is replaced by the PAN, this together with the graphic asset information updates the graphics associated with that PAN in the transaction card server 400 graphic assets vault.

13. When the digital wallet application updates its meta data for enrolled transaction cards, the asset data for the chosen graphics are displayed on the relevant transaction card or cards.

It will be appreciated that the call to Card Meta Data Update Notification can be made as often as is required to support the user's preferences made in the consumer app, and for this reason, multiple images or graphics may be associated with each payment card in the management server. This allows the management server to identify when a predetermined condition is met and to automatically send an update notification to the transaction card server 400 via the tokenization platform to update the transaction card graphics data. When the digital wallet application next contacts the transaction card server 400, the graphics will be updated according to the predetermined condition.

In summary, there is provided a system, method, and device for managing a digital wallet application. The system comprises a user electronic device 200 comprising a communicator 201, and a processor 207 communicatively coupled to the communicator 201. The processor 207 executes a digital wallet application which is arranged to display a graphic asset associated with a digitised transaction card. The processor 207 obtains graphic asset preference information in relation to the digitised transaction card. The communicator 201 communicates the graphic asset preference information to a management server 300. The communicator 201 receives, from the management server 300, asset information for a replacement graphic asset determined according to the graphic asset preference information. The processor 207 replaces the graphic asset associated with the digitised transaction card with the replacement graphic asset according to the communicated asset information such that the digital wallet application is arranged to display the replacement graphic asset associated with the digitised transaction card.

Referring to FIG. 10, there is shown a system 800 according to another aspect of the present invention which is configured to provide a platform for trading, sharing, and storing of digital assets such as loyalty schemes. The system comprises user electronic devices 200A, 200B, 200C which may be the same as the user electronic device 200 described above. The user electronic devices 200A, 200B, 200C are associated with different users. The system further comprises a transaction database 801. The transaction database may keep a record of the trade of digital assets, and the value of the traded digital assets. The system 800 further comprises merchant entities 803A, 803B that provide digital assets, e.g. as part of a loyalty scheme. The ownership, transfer and assignment of digital assets may be managed and validated by a distributed ledger 805 (e.g. a blockchain), which may be in the form of a permissioned distributed ledger 805. The distributed ledger may create a secure and, optionally, pubic network for digital asset sharing and trading. In other words, the system as shown in FIG. 10 is useable for trading digital assets, while keeping track of the ownership of the digital assets, and enabling redemption of the digital assets.

The user electronic devices 200A, 200B, 200C run digital wallet applications and optionally additional consumer applications. The digital wallet applications and consumer applications may be operable in combination to allow personalisation or update of existing graphic assets associated with digitised transaction cards in the digital wallet application.

A user of user electronic device 200A may comprise a digitised transaction card in the digital wallet application with a particular associated graphic asset. The graphic asset may be linked to a loyalty point scheme such that use of the digitised transaction card when associated with the graphic asset results in the generation of loyalty points.

The user may wish to transfer, e.g. by buying, selling, or exchanging, digital assets to another user possibly in exchange for another kind of digital asset, e.g. loyalty points for a different loyalty scheme. To this end, the user may advertise their willingness to trade loyalty points to other user electronic devices 200A, 200B, 200C within the system 800. The user may provide a command to the user electronic device 200A for effecting the transfer via a user interface or via a voice input. The transfer may be performed locally (e.g. to user electronic device 200B), or over a wide area network (e.g. to user electronic device 200C).

In response to a user of the user electronic device 200B, 200C accepting the offer to trade loyalty points, the system 800 begins a process for transferring the digital asset from the user of user electronic device 200A to the user of the other user electronic device 200B, 200C. In a first stage of the process, the first user is authenticated as the owner of the digital asset by inspecting the transaction database 801. Then the digital asset is transferred from the user of user electronic device 200A to the user of the other user electronic device 200B, 200C by: updating the transaction database 801 so as to identify the second user as the owner of the digital asset; and by providing a graphic asset associated with the digital asset to a user electronic device of the second user.

The graphic asset may be provided using the system and techniques disclosed above in relation to FIGS. 1 to 9.

The user electronic device 200B, 200C may update a digital wallet using the provided graphic asset so that the digital asset is associated with a digitised transaction card of the digital wallet application. This may involve adding a new digitised transaction card to the digital wallet application and associating the new digitised transaction card with the provided graphic asset. This may involve replacing the graphic asset associated with the digitised transaction with the provided graphic asset.

The provided graphic asset is associated with a digital asset which may be a number of loyalty points belonging to a loyalty point scheme. The providing of the graphic asset from the user electronic device 200A to the user electronic device 200B, 200C effects the transfer of the digital asset (the loyalty points) to the user electronic device 200B, 200C. This may mean that the user of user electronic device 200B, 200C is able to spend or transfer the digital asset using the digitised transaction card associated with the provided graphic asset in their digital wallet application. In addition or separately, subsequent transactions performed using the digitised transaction card when associated with the provided graphic asset may generate further digital assets (e.g. more loyalty points).

The transfer of digital assets may be performed separately or in addition to the replacement of graphic assets according to preference information as described above in relation to FIGS. 1 to 9.

In summary, there is provided a method and system for transferring a digital asset. The method comprises transferring a digital asset from a first user to a second user. The method comprises authenticating the first user as the owner of the digital asset by inspecting a transaction database. The method comprises transferring the digital asset from the first user to the second user by updating the transaction database so as to identify the second user as the owner of the digital asset; and by providing a graphic asset associated with the digital asset to a user electronic device of the second user. The transfer of the digital asset may be validated using a distributed ledger such as a blockchain. The method may be performed by a system 800 comprising user electronic devices 200A, 200B, 200C, and a transaction database 801.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Although a few preferred embodiments of the present invention have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer-implemented method of transferring a digital asset from a first user to a second user, the method comprising:
authenticating the first user as the owner of the digital asset by inspecting a transaction database; and
transferring the digital asset from the first user to the second user by:
updating the transaction database so as to identify the second user as the owner of the digital asset; and
providing a provided graphic asset associated with the digital asset to a user electronic device of the second user.

2. The method according to claim 1, further comprising updating a digital wallet application of the user electronic device of the second user using the provided graphic asset so that the digital asset is associated with a digitised transaction card of the digital wallet application.

3. The method according to claim 2, wherein updating the digital wallet application comprises adding a digitised transaction card to the digital wallet application and associating the digitised transaction card with the provided graphic asset.

4. The method according to claim 2, wherein updating the digital wallet application comprises updating an existing digitised transaction card in the digital wallet application by replacing the existing graphic asset associated with the digitised transaction card with the provided graphic asset.

5. The method according to claim 1, wherein transferring the digital asset further comprises providing metadata associated with the graphic asset, the metadata comprising an identifier for the graphic asset, and optionally wherein the identifier links the graphic asset to a record of the digital asset in the transaction database.

6. The method according to claim 1, wherein the first user is associated with a user electronic device comprising a digital wallet application, the digital wallet application comprising a digitised transaction card associated with a graphic asset and a digital asset.

7. The method according to claim 6, wherein in response to receiving a request for the first user to transfer the digital asset to the second user, the method comprises disassociating the graphic asset from the digitised transaction card.

8. The method according to claim 6, wherein in response to receiving a request for the first user to transfer a part of the digital asset to the second user, the method comprises obtaining another graphic asset; associating the another graphic asset with the part of the digital asset; updating the transaction database so as to identify the second user as the owner of the part of the digital asset; and providing the another graphic asset to the user electronic device of the second user.

9. The method according to claim 1, wherein the digital asset is transferred in response to receiving a request to transfer the digital asset.

10. The method according to as claimed in-claim 9, wherein the request is provided in response to the electronic device of the second user receiving information regarding the digital asset of the first user, and optionally wherein the information regarding the digital asset of the first user is provided to a plurality of electronic devices associated with a plurality of users.

11. The method according to claim 1, wherein the transfer of the digital asset from the first user to the second user is in exchange for a second digital asset from the second user.

12. The method according to claim 11, further comprising:
authenticating the second user as the owner of the second digital asset by inspecting a transaction database; and
transferring the second digital asset from the second user to the first user by:
updating the transaction database so as to identify the first user as the owner of the second digital asset; and
providing a second graphic asset to a user electronic device of the first user, the metadata comprising information identifying the nature of the second digital asset.

13. The method according to claim 1, wherein the database is a distributed ledger, and optionally wherein the distributed ledger is a permissioned distributed ledger, and optionally wherein the distributed ledger is a blockchain.

14. A computer program comprising instructions which when executed by a computer cause the computer to perform a method of transferring a digital asset from a first user to a second user, the method comprising:
authenticating the first user as the owner of the digital asset by inspecting a transaction database;
transferring the digital asset from the first user to the second user by:
updating the transaction database so as to identify the second user as the owner of the digital asset; and
providing a graphic asset associated with the digital asset to a user electronic device of the second user.

15. A computerised system for transferring a digital asset from a first user to a second user, the system being arranged to:
authenticate the first user as the owner of the digital asset by inspecting a transaction database; and
transfer the digital asset from the first user to the second user by:
updating the transaction database so as to identify the second user as the owner of the digital asset; and
providing a graphic asset associated with the digital asset to an electronic device of the second user.

16-30. (canceled)
